(19) United States
(12) Patent Application Publication
(10) Pub. No.: US 2005/0284215 A1
(43) Pub. Date: Dec. 29, 2005

(54) Method and apparatus for preoperative estimation of breast implant volume

(76) Inventor: Andrew Eugene Falsetti, Presto, PA (US)

Correspondence Address: Andrew E. Falsetti, Esq., 2301 Hidden Timber Drive, Pittsburgh, PA, 15241, US

(21) Appl. No.: 10/878,190

(22) Filed: Jun. 28, 2004

(51) Int. Cl. G01F 17/00

(52) U.S. Cl. 73/149

(57) ABSTRACT

A method and apparatus for the preoperative estimation of breast implant volume, In which a volume of air, water, or other substance is used to inflate one or more bladders located within the cups of the brassiere-like garment. The apparatus is operated by pumping an amount of air from the outside atmosphere, or water or another substance from a reservoir or external water supply, into the bladders, according to the patient's preference as to the size of breasts she desires. A gauge is used to measure the capacity of each bladder when inflated to its desired size. The volume of each bladder as measured by the gauge can then be used to determine the size of breast implant to be used during breast augmentation surgery.

### BACKGROUND OF THE INVENTION

1. Field of the Invention

A method and an apparatus for the preoperative estimation of the volume of breast implants, and, more specifically, a brassiere-like garment which includes expandable and deflatable bladders which are filled with a measured amount of fluid or air to determine the desired volume of implant to be used during breast augmentation surgery.

2. Description of the Background

Breast augmentation surgery is one of the most widely performed cosmetic surgery procedures today. Many women who desire to increase the size of their breasts undergo procedures to achieve larger breast size through the surgical placement of breast implants. Additionally, women who have suffered breast trauma or infection, have required mastectomies due to cancer, or have congenital breast asymmetry or other deformities of the breasts often seek to improve their appearance or restore their previous appearance through the surgical placement of breast implants.

Breast implants are commonly made of a plastic shell that is filled with a saline solution or a silicone gel. Various other materials or methods have been used and could later be developed to augment the breasts which would also benefit from the present invention. The amount of saline, silicone, or other material with which the shell is filled will determine the size of the woman's breasts post augmentation.

Before undergoing breast augmentation surgery, women and their surgeons must decide what volume of implant is to be used. This decision is based largely upon patient preference, but also may be limited by the patient's anatomy or other medical concerns. Traditionally, it has been difficult for a woman to communicate adequately what size breasts she desires to obtain through the surgery. Preexisting methods have been inadequate and inaccurate, and include simply requesting a certain brassiere cup size, providing a photograph of another woman whose breasts match the patient's preference, and/or filling small bags with measured amounts of rice and inserting them into the woman's brassiere. These methods often result in a rather poor estimation of the desired post surgical breast size, and thus women may be dissatisfied with the size of their breasts following the implantation surgery.

As such, a need exists for a simpler and more accurate method and apparatus to estimate the size of breast implants to be used in augmentation surgery.

### SUMMARY OF THE INVENTION

A method and apparatus for the preoperative estimation of breast implant volume to allow for the simplified measurement of the volume of implants to be used in breast augmentation surgery. The patient puts on the garment as she would a normal brassiere. An expandable and deflatable bladder is located inside each cup of the garment. The patient, physician, or other person then operates the device by filling one or both of the bladders with a defined amount of air, water, or other substance that is pumped into one or both of the bladders from either the atmosphere, in the case of an air-based system, or, in a liquid-based system, from either a reservoir containing a sufficient amount of water or other substance, or from an external water supply. Measurement of the volume of air, water, or other substance that has entered the bladder or bladders is made through the use of a gauge. The woman may then examine her appearance wearing only the device, or wearing the device underneath other garments. She may then adjust the volume that is held in the bladders either upward or downward according to her preference and thus derive a measurement that closely approximates the desired size of breast implant to be used in breast augmentation surgery.

### BRIEF DESCRIPTION OF THE DRAWINGS

For the present invention to be clearly understood and readily practiced, the present invention will be described in conjunction with the following figures, wherein like reference characters designate the same or similar elements, which figures are incorporated into and constitute a part of the specification, wherein:

FIG. 1 shows the apparatus of the present invention and its corresponding component parts.

FIG. 2 illustrates the step-by-step method of practicing of the present invention.

### DETAILED DESCRIPTION OF THE INVENTION

It is to be understood that the figures and descriptions of the present invention have been simplified to illustrate elements that are relevant for a clear understanding of the invention, while eliminating, for purposes of clarity, other elements that may be well known. Those of ordinary skill in the art will recognize that other elements are desirable and/or required in order to implement the present invention. However, because such elements are well known in the art, and because they do not facilitate a better understanding of the present invention, a discussion of such elements is not provided herein. The detailed description will be provided herein below with reference to the attached drawings.

### EXAMPLE 1

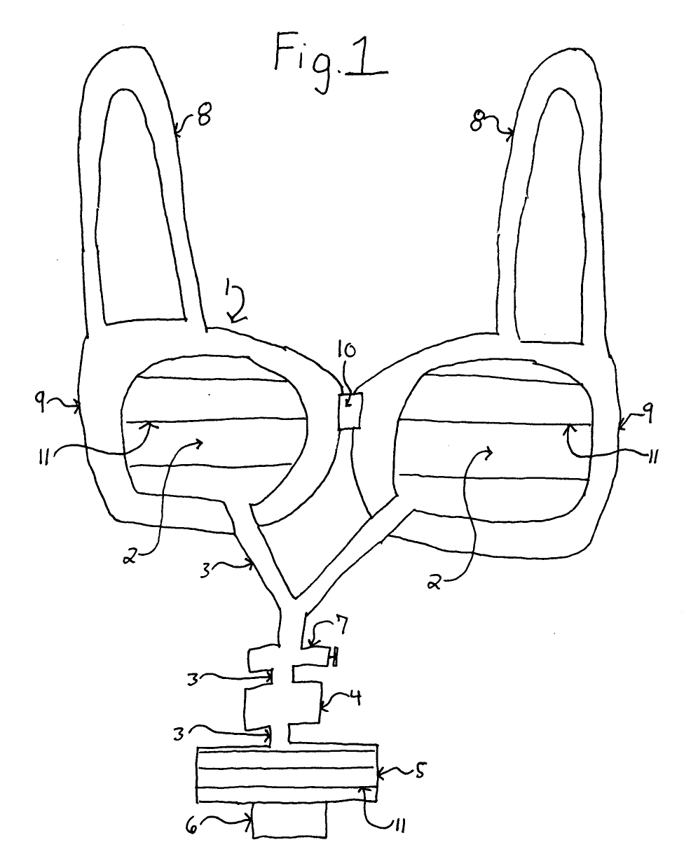

In at least one preferred embodiment, as shown in FIG. 1, the present invention comprises a brassiere-like garment 1 containing two fluid-filled bladders 2 used to practice the method of preoperatively estimating the desired volume of implant to be used in subsequent breast augmentation surgery.

The garment 1 is similar to a standard brassiere, and includes straps 8 to be worn over the woman's shoulders, two cups 9 which hold the breasts, and a closure 10 that is used to secure the garment 1 on the woman's body. The closure 10 may be located at the front of the garment 1 between the cups 9, or it may be located at the back of the garment 1, resting against the patient's back. The closure 10 can be fashioned from metal or plastic hooks, Velcro, or any other suitable means to secure the garment 1 on the patient's body. The garment 1 itself may be made of any natural or synthetic fabric that is suitably elastic and durable. It is contemplated that the garment 1 could be produced in a variety of sizes and/or is adjustable at the closure 10 point and/or on the straps 8. This would allow for women of various body sizes to wear the garment 1 and practice the method of the invention.

The first step in the method of the present invention is for the woman to put on the garment 1 as she would a normal brassiere. Once the garment 1 is correctly positioned on the woman's body, the bladders 2 are inflated to simulate the appearance of surgically-placed breast implants. The bladders 2 may be made of any suitable material for containing a fluid, such as, but not limited to, various plastics or rubbers. The patient or another individual, such as a physician, nurse, healthcare worker, etc., then activates the pump 6 to inflate the bladders 2. In the event that a woman will only be receiving a breast implant in one breast, for example, in breast reconstruction surgery, a garment 1 containing only one bladder 2 could be used, or the tubing 3 leading to the bladder 2 over the breast that will not be augmented can be clamped off

The bladders 2 will receive the fluid as it is drawn upward through the tubing 3 from the reservoir 5 by the action of the pump 6. The reservoir 5 is a simple bag or tank made of any waterproof material which contains the fluid used to fill the bladders 2 when the invention is practiced. The reservoir 5 may contain a port for emptying or refilling the fluid, or the port may be absent in a sealed version of the apparatus. Alternatively, instead of a reservoir 5, the lower portion of tubing 3 could be connected through a water faucet adaptor to a water faucet, and the invention could be practiced by simply turning the water flow on and off, and utilizing the water pressure of this external water supply to propel the water through the tubing 3, thus eliminating the need for a pump 6. Another similar alternative would employ the use of a fluid-filled syringe attached to a syringe port connected to the tubing 3, and the depression of the syringe would push fluid into the tubing 3 to inflate the bladders 2.

In the embodiments of the present invention that do contain a pump 6, the pump 6 may be a simple squeezable bulb operated manually to propel the liquid through the tubing 3. For example, the bulb could be similar to those commonly found on manual blood pressure cuffs. Alternatively, the pump 6 could be electric, powered either by a connection to a standard wall outlet or through the use of batteries. Once the pump 6 is activated by the user either by squeezing the bulb on a manual system or by turning on a power switch on an electric system, the fluid contained in the reservoir 5 is propelled upwards through tubing 3, which is made of plastic or another suitable flexible and waterproof material, to the bladders 2, which are attached to the garment 1 within the cups 9 that hold the woman's breasts. As the fluid ascends through the tubing 3, it enters and fills the bladders 2, thus inflating them to simulate the appearance of the surgical placement of breast implants.

A gauge 4 is used to measure the amount of fluid that has entered the bladders 2. The gauge 4 may function in a variety of ways. In one simple form, the gauge 4 could be nothing more than simple measurement lines found on the reservoir 5. For example, measurement lines could be placed from the top of the reservoir 5 descending downward, corresponding to the volume of fluid that has left the reservoir 5, which therefore indicates the volume of fluid now held in the bladders 2. Similarly, measurement lines could be placed on another part of the apparatus, such as on the bladders 2, on the tubing 3 below the bladders 2, or at such other position on the apparatus in which it is convenient to read a measurement. Alternatively, the gauge 4 may be another type of device capable of measuring a fluid volume and providing a measurement to the user. By way of example only, an electronic gauge 4 could be attached to the apparatus within the tubing 3 between the reservoir 5 and the bladders 2. Regardless of its specific location or method of operation, the gauge 4 is employed to measure the amount of fluid that has entered the bladders 2 and provides a reading of this volume to the user.

Once the bladders 2 have been filled with fluid, the patient may examine her appearance while wearing the garment 1 with or without clothing over top of it. When the patient has achieved a desired breast size as simulated by the inflation of the bladders 2, the patient may stop the further flow of fluid into the bladders 2 by deactivating the pump 6 or turning off the external water supply. To prevent the downward flow of the liquid out of the bladders 2, a tubing lock 7 is turned to its closed position, thus blocking the downward flow of fluid through the tubing 3.

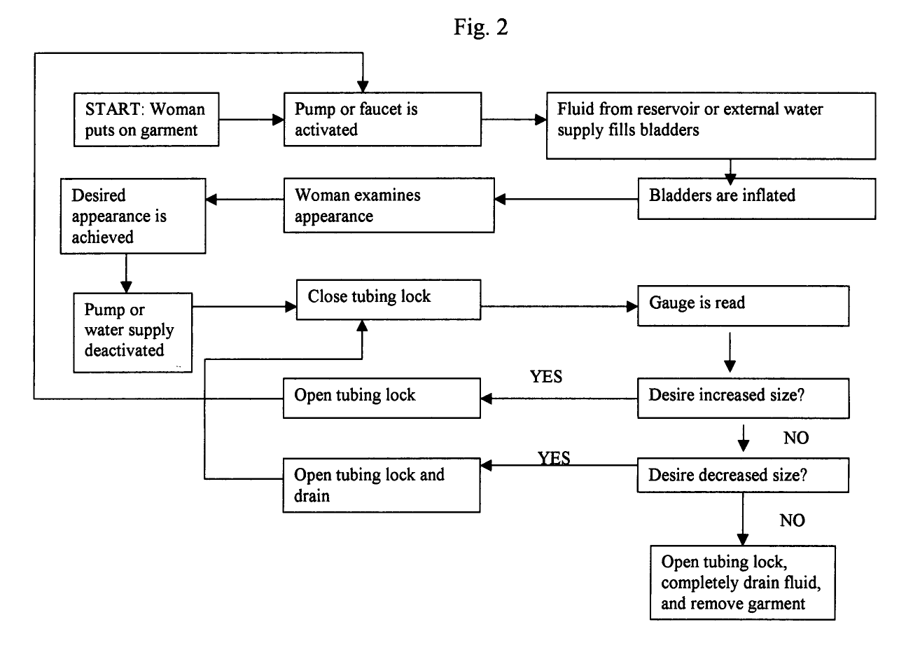

The patient may then read the gauge 4 to determine the volume of fluid that is held within the bladders 2. This measurement provides an accurate estimation of the volume of breast implant that the woman desires to be used in the breast augmentation procedure to achieve her desired appearance post surgery. Should the woman desire to further adjust the volume in the bladders 2, she may do so. To increase the volume of fluid within the bladders 2, she may simply turn the tubing lock 7 into its open position and practice the method of the invention as before. If the patient desires to decrease the volume of fluid within the bladders 2, she may simply turn the tubing lock 7 into its open position and allow an amount of fluid to drain out of the bladders 2, either back into the reservoir 5. If an external water supply has been connected, the tubing 3 is disconnected from the water faucet and the excess water is drained into the sink. Similarly, when use of the device has been completed, the water or other fluid can be drained from the bladders 2 in these same ways, and the woman may then remove the garment 1. The complete method of the present invention is summarized in FIG. 2.

### EXAMPLE 2

In another embodiment of the invention that is substantially similar to the above example in composition and operation, the bladders 2 can be inflated with air from the outside atmosphere. In this embodiment, the reservoir 5 is replaced by an air intake which, through the aid of the pump 6, draws air into the device and inflates the bladders 2. The gauge 4 would also necessarily be one that measures the volume of air within the bladders 2. An air-based version of the device is practiced by essentially the same method as in the preceding example, excepting that opening the tubing lock 7 after inflation of the bladders 2 will result in the air escaping from the device and back into the atmosphere.

Nothing in the above description is meant to limit the present invention to any specific materials, geometry, or orientation of elements. Many part/orientation substitutions are contemplated within the scope of the present invention and will be apparent to those skilled in the art. The embodiments described herein were presented by way of example only and should not be used to limit the scope of the invention.

Although the invention has been described in terms of particular embodiments in an application, one of ordinary skill in the art, in light of the teachings herein, can generate additional embodiments and modifications without departing from the spirit of, or exceeding the scope of, the claimed invention. Accordingly, it is understood that the drawings and the descriptions herein are proffered only to facilitate comprehension of the invention and should not be construed to limit the scope thereof.

1. An apparatus for preoperative estimation of a breast implant volume comprising:
a brassiere-like garment to be worn by a woman;
one or two bladders attached to brassiere cups on said brassiere-like garment;
tubing connecting said bladders to a sealed fluid-filled reservoir;
a pump to move a fluid from said sealed fluid-filled reservoir to said bladders; and
a volume gauge to measure a volume of said fluid indicating a desired value for said breast implant volume.

2. The apparatus of claim 1, wherein said volume gauge is comprised of measurement lines on said sealed fluid-filled reservoir or said bladders.

3. The apparatus of claim 1, wherein said volume gauge is electronic.

4. The apparatus of claim 1, wherein said pump is manual.

5. The apparatus of claim 1, wherein said pump is electric.

6. The apparatus of claim 1, wherein said fluid is water.

7. The apparatus of claim 1, wherein said fluid is a non-aqueous substance.

8. An apparatus for preoperative estimation of a breast implant volume comprising:
a brassiere-like garment to be worn by a woman;
one or two bladders attached to brassiere cups on said brassiere-like garment;
tubing connecting said bladders to an external water supply a water faucet adaptor; and
a volume gauge to measure a volume of a fluid indicating a desired value for said breast implant volume.

9. The apparatus of claim 8, wherein said volume gauge is comprised of measurement lines on said bladders.

10. The apparatus of claim 8, wherein said volume gauge is electronic.

11-19. (canceled)

20. A method for preoperatively estimating the volume of breast implants comprising the steps of:
putting on a brassiere-like garment;
activating a pump or an external water supply;
examining one's appearance while wearing said brassiere-like garment;
deactivating said pump or said external water supply;
closing a tubing lock; and
reading a volume gauge.

21. The method of claim 20, further comprising the steps of:
Opening said tubing lock;
Draining a fluid from a set of bladders;
Removing said brassiere-like garment.

22. The method of claim 20, further comprising the steps of:
opening said tubing lock;
reactivating said pump or said external water supply;
reexamining one's appearance while wearing said brassiere-like garment;
deactivating said pump or said external water supply;
closing said tubing lock; and
reading said volume gauge.

23. The method of claim 21 further comprising the steps of:
opening said tubing lock;
draining a fluid from a set of bladders;
closing said tubing lock; and
reading said volume gauge.

24. An apparatus for preoperative estimation of breast implant volume comprising:
a brassiere-like garment;
one or two bladders attached to brassiere cups on said brassiere-like garment;
tubing connecting said bladders to an external water supply; and
a volume gauge, wherein said volume gauge is comprised of measurement lines on said bladders.
